(19) United States
(12) Patent Application Publication
(10) Pub. No.: US 2018/0058138 A1
(43) Pub. Date: Mar. 1, 2018

(54) Decorative Door Shroud

(71) Applicant: Britlyn H. Binder, Marlton, NJ (US)

(72) Inventor: Britlyn H. Binder, Marlton, NJ (US)

(21) Appl. No.: 15/682,622

(22) Filed: Aug. 22, 2017

Related U.S. Application Data
(60) Provisional application No. 62/378,431, filed on Aug. 23, 2016.

(51) Int. Cl. E06B 3/30; E06B 7/28; A47H 99/00; B44C 5/04

(52) U.S. Cl. CPC E06B 3/30; B44C 5/04; A47H 99/00; E06B 7/28

(57) ABSTRACT

A shroud configured to encompass a door which allows both the front side and back side surfaces of the door to be decorated with art work. The shroud is made of stretchable, expandable fabric, configured to encompass and be secured around the door. The shroud can have patterns, images, or other decorations printed directly thereon. The cover can also be blank, thus allowing the user to draw, paint, mark-up, or otherwise decorate the cover. The user will be able to upload photographs or artwork to create customized covers online as well. The shroud is removeable and may be washable. It can then be re-installed on the door, allowing for different decorations or art work. Different shrouds can be interchangeably installed on a door.

### RELATED APPLICATION

This application claims the benefit of application Ser. No. 62/378,431, filed on Aug. 23, 2016.

### BACKGROUND OF THE INVENTION

Decorative door art work is not uncommon. However, the present invention is directed to a unique means of decorating a door and either maintaining the door design, or changing it as often as the decorator desires.

### SUMMARY OF THE INVENTION

The present invention is a shroud specifically configured to be installed over a door which allows both the front side and back side surfaces of the door to be decorated with art work. The shroud comprises stretchable, expandable fabric which is configured to substantially encompass and be secured around the door. The shroud can have patterns, images, or other decorations printed directly thereon. The cover can also be blank, thus allowing the user to draw, paint, mark-up, or otherwise decorate the cover with designs of choice. It is contemplated that the user will be able to upload photographs or artwork to create customized covers online as well. The shroud is removeable and may be washable, depending on the material used on the shroud for decoration. It can then be re-installed on the door, making different decorations or art work available. It is also contemplated that different shrouds can be interchangeably installed on a door.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a perspective view of the shroud of the present invention in line to be installed over a door.

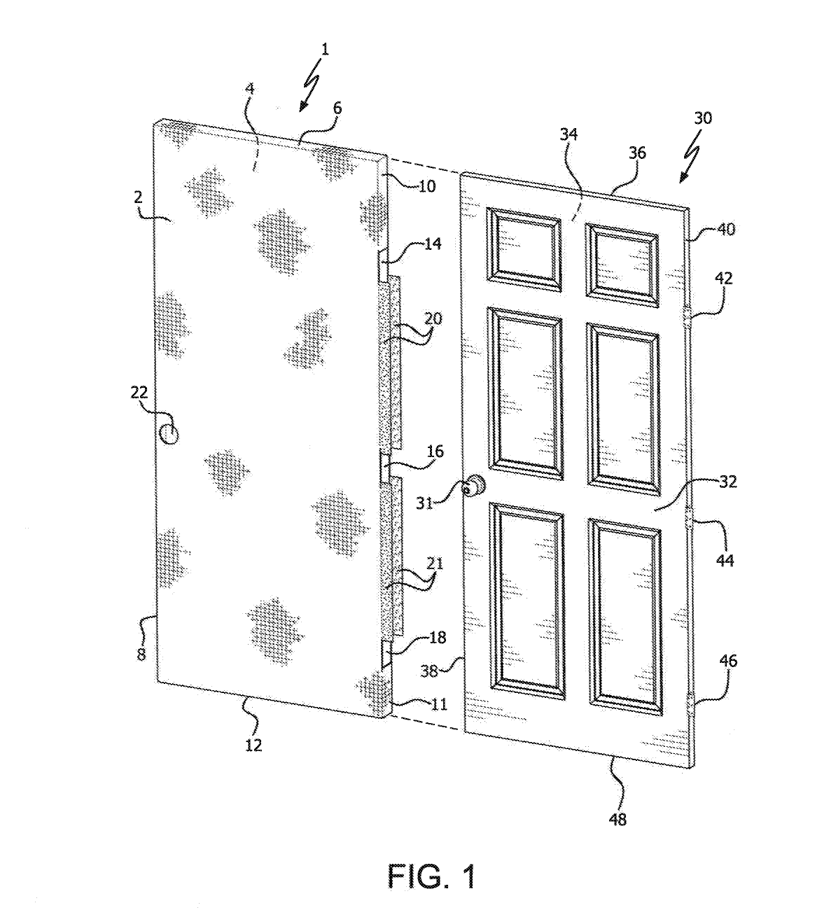

FIG. 2 is a view of the shroud of the present invention in place, encompassing a door.

### DETAILED DESCRIPTION OF THE INVENTION

Shroud 1 of the present invention comprises a single, unitary cover made of a stretchable, expandable fabric. Shroud 1 has front section 2, back section 4, top section 6, front end section 8, upper back end section 10, lower back end section 11, and bottom section 12. Top section 6, front end section 8, back end sections 10 and 11, and bottom section 12 are located between front section 2 and back section 4. Cover connection means, in the form of loop and hook connectors like Velcro® or equivalent connectors 20 and 21, are attached to front section 2 and back section 4. Cut-out 22 provides an opening for a door knob.

Shroud 1 is stretched and then positioned over and around door 30, such that front section 2 covers front side surface 32 of the door with door knob 31 extending through cut-out 22, back side section 4 covers back side surface 34 of the door with the opposite door knob extending through a cut-out in the back section, top section 6 covers top end 36 of the door, front end section 8 covers front end 38 of the door, and back end sections 10 and 11 partially cover back end 40 of the door such that door hinges 42, 44, and 46 can extend through openings 14, 16 and 18 at the back end of the door, adjacent to cover connection means 20 and 21. Bottom section 12 covers bottom 48 of the door.

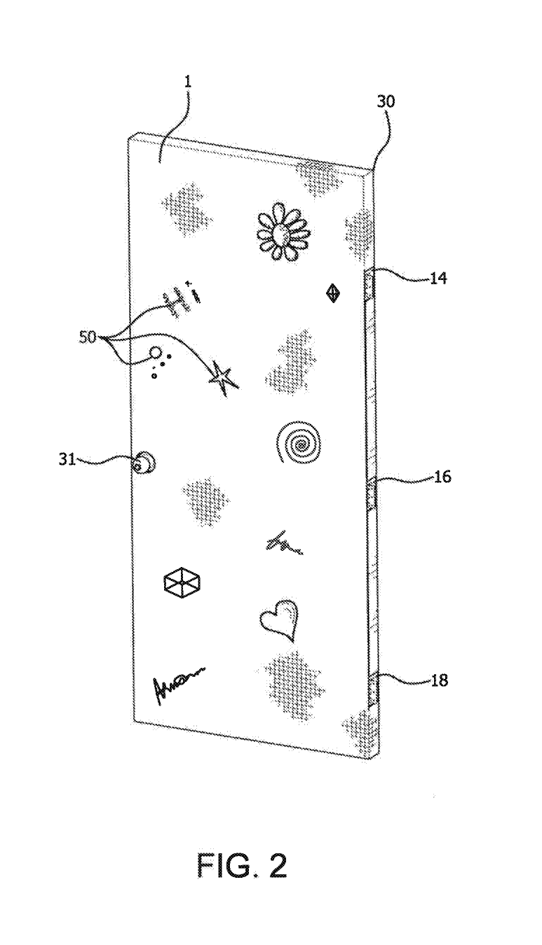

In this manner, shroud 1 completely encompasses door 30, which, if it does not already have art work, is ready to be decorated. FIG. 2 shows examples of door 30 having art work decorations 50. Shroud 1 can also be easily removed from door 30 at any time.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A decorative shroud for encompassing the front side surface, the back side surface, the front end, and the top of a door, the shroud comprising:
a single, unitary cover made of stretchable, expandable fabric having decorative images, colors, or lettering thereon, said cover having a front section, a back section, a top section, and a front end section, the top section and the front end section being located between the front section and the back section; and
cover connection means for securing the front section and back section of the cover together to secure the shroud to the door, whereby the shroud encompasses the door by stretching and expanding the cover over the door such that the front section of the cover is over the front surface of the door, the back section of the cover is over the back side surface of the door, the top section of the cover is over the top end of the door, and the front end section of the cover is over the front end of the door.

2. The decorative shroud as in claim 1 wherein the cover connection means are adjacent to openings at the back end of the door to allow for door hinges.

3. The decorative shroud as in claim 1 wherein the cover has back end sections which overlay the back end of the door.

4. The decorative shroud as in claim 1 wherein the cover has a bottom section which encompasses a bottom of the door.

5. The decorative shroud as in claim 4 wherein the cover has back end sections which overlay the back end of the door.

6. The decorative shroud as in claim 1 wherein the cover connection means comprises hook and loop attachments.

7. A decorative shroud for encompassing the front side surface, the back side surface, the front end, and the top of a door, the shroud comprising:
a single, unitary cover made of stretchable, expandable fabric said cover having a front section, a back section, a top section, and a front end section, the top section, front end section, and back section being located between the front section and the back section; and
cover connection means for securing the front section and back section of the cover together to secure the shroud to the door, whereby the shroud encompasses the door by stretching and expanding the cover over the door such that the front section of the cover is over the front surface of the door, the back section of the cover is over the back side surface of the door, the top section of the cover is over the top end of the door, and the front end section of the cover is over the front end of the door.

8. The decorative shroud as in claim 7 wherein the cover connection means are adjacent to openings at the back end of the door to allow for door hinges.

9. The decorative shroud as in claim 7 wherein the cover has back end sections which overlay the back end of the door.

10. The decorative shroud as in claim 7 wherein the cover has a bottom section which encompasses a bottom of the door.

11. The decorative shroud as in claim 10 wherein the cover has back end sections which overlay the back end of the door.

12. The decorative shroud as in claim 7 wherein the cover connection means comprises hook and loop attachme
